(19) United States
(12) Patent Application Publication
(10) Pub. No.: US 2005/0274250 A1
(43) Pub. Date: Dec. 15, 2005

(54) Saw blade locking apparatus

(76) Inventors: Timothy Brown, Circle Pines, MN (US); Jim Lee, Webster, SD (US); Doug Antonson, So. St. Paul, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/138,029

(22) Filed: May 26, 2005

Related U.S. Application Data
(60) Provisional application No. 60/574,745, filed on May 27, 2004.

(51) Int. Cl. B26D 1/12

(52) U.S. Cl. 83/665

(57) ABSTRACT

A self-locking collar assembly for a saw blade is provided, in addition to a saw blade per se and a sawing machine characterized by the assembly of the subject invention. The subject assembly preferable and advantageously includes a collar having an inner periphery adapted for receipt upon a spline, with the collar adapted for affixation to a saw blade. A self-locking link is pivotally mounted at an end thereof to a portion of a surface of the collar. The self-locking link includes a spline engaging lobe for axially affixing the saw blade to the spline in furtherance of producing a pre-select dimensional rip of a work piece.

This is a regular application filed under 35 U.S.C. §111(a) claiming priority under 35 U.S.C. §119(e) (1), of provisional application Ser. No. 60/574,745 having a filing date of May 27, 2004.

### TECHNICAL FIELD

The present invention generally relates to a saw blade locking apparatus, more particularly, a self-locking saw blade collar assembly for use in gang rip saws and the like, saw blades so adapted, and sawing machines utilizing same.

### BACKGROUND OF THE INVENTION

Historically, gang rip saws, such as those by Mereen-Johnson Machine Co. of Minneapolis, Minn., e.g., Mereen-Johnson Machine Co. Model 400, utilized removable saw sleeves with spacers placed between saw blades to create the desired or sought after net rips. In the context of changeovers for the multiple rip saw (i.e., blade setting or spacing alteration), the method attendant to utilization of the saw sleeves is known to offer high accuracy, however, it requires substantial down time. Recently, the removable saw sleeve approach, and methodology associated therewith, was improved with the introduction of oil or grease-activated expansion mechanisms which allow the setting of saw blades on the gang rip saw without reliance upon a removable sleeve or spacer structure. Although this improved approach or technique reduces set-up time, operators continued to struggle with issues of accuracy, reliability, and maintenance of the required mechanisms. A further and critical drawback of this approach is that when the mechanical system fails, the saw becomes unusable, resulting in costly down time, necessitating costly repairs.

A further, alternate development to fluid expansion mechanisms for integrating a saw blade and an arbor, e.g., a spline, or spindle is disclosed in U.S. Pat. No. 5,293,798 (Otani et al.). Essentially, a one way, on/off clutch is provided between the saw blades and the spindle. While the spindle is rotating at a low speed or is at a stop, the clutch is in its inoperative position, keeping the saws disengaged from the spindle so that the distances between the adjacent saws can be adjusted freely. When the spindle begins to rotate at a high speed, the clutch is finally activated, by centrifugal force, the spindle thereby engaged, and the saw blades in turn locked the spindle.

In addition to the aforementioned shortcomings of heretofore known devices and/or methods, it is further critical that the saw blade not move while positioning other blades, or during the locking activation process. Oil/hydraulic expansion systems do not suitably satisfy this requirement, as all blades remain loose until being locked up simultaneously by the expansion mechanism. Similarly, Otani et al. suffer from such saw blade positioning instability, as only an on/off mechanical approach is provide, i.e., as high speed spindle rotation is required for even minimal engagement between portions of the clutch with the spindle, assurance of precise, preselect rips are far from certain. Thus, there remains a need to provided a mechanism by which saw blades may quickly and reliably be axially positioned along a spindle or the like to produce targeted repeated rips with no down time for inadvertent saw blade travel, or more generally, misalignment. Furthermore, it is believed advantageous to provide a simple mechanical mechanism which progressively unites a saw blade with a spindle.

### SUMMARY OF THE INVENTION

A self-locking collar assembly for a saw blade is provided, in addition to a saw blade per se and a sawing machine characterized by the assembly of the subject invention. The subject assembly preferable and advantageously includes a collar having an inner periphery adapted for receipt upon an arbor or a spline, with the collar adapted for affixation to a saw blade. A self-locking link is pivotally mounted at an end thereof to a portion of a surface of the collar. The self-locking link includes an arbor or a spline engaging lobe for axially affixing the saw blade to the arbor in furtherance of producing a pre-select dimensional rip of a work piece.

The subject self-locking collar assembly provides for fast, accurate, and reliable changeovers for saw blades of the multiple rip saw. The assembly provides progressive locking of the saw to the saw arbor or spindle. Advantageously, self-locking collar assembly is for use on gang rip saws that have two or more saw blades on an arbor. The collar is preferably used, for example, with four or five other collars on a single double-keyed 2 9/16″ diameter saw arbor which may be equipped with 12″ or 14″ diameter saw blades. The subject collar utilizes the natural occurrence of centrifugal force generated by the rotation of the saw arbor to simultaneously lock the saw blades into their desired positions.

Saw position changeover is as easy as stopping the saw arbor, axially moving the saw blade or blades to the new desired position, and restarting the arbor. Due to the configuration of the subject collar, more particularly select structures thereof and their interrelationships, two distinctly different fits are provided for one or more saw blades upon the arbor, one for static (i.e., passive) and one for dynamic (i.e., active) operational modes. More specific features and advantages obtained in view of those features will become apparent with reference to the drawing figures and DETAILED DESCRIPTION OF THE INVENTION.

### BRIEF DESCRIPTION OF THE DRAWINGS

Referring now to the drawings wherein like numerals are used to designate like parts of the invention throughout the figures:

FIG. 1 is a perspective sectional view of a sawing machine spline depicting thereon the self-locking collar assembly of the subject invention in combination with a saw blade, portions broken away, a self-locking link shown disengaged from the arbor;

FIG. 2 depicts an end on view of the perspective sectional view of FIG. 1;

FIG. 3 depicts the general arrangement of FIG. 1 wherein the self-locking link is shown in an active or activated operational condition, namely, operatively engaged with the arbor;

FIG. 4 depicts an end on view of the perspective sectional view of FIG. 3;

FIG. 5 is a perspective plan view of the self-locking collar assembly of the subject invention;

FIG. 6 is a partially exploded view of the assembly of FIG. 5 depicting the relationship between the self-locking link and the collar; and,

FIG. 7 illustrates the “underside” of the self-locking link of FIG. 6 and related structures.

### DETAILED DESCRIPTION OF THE INVENTION

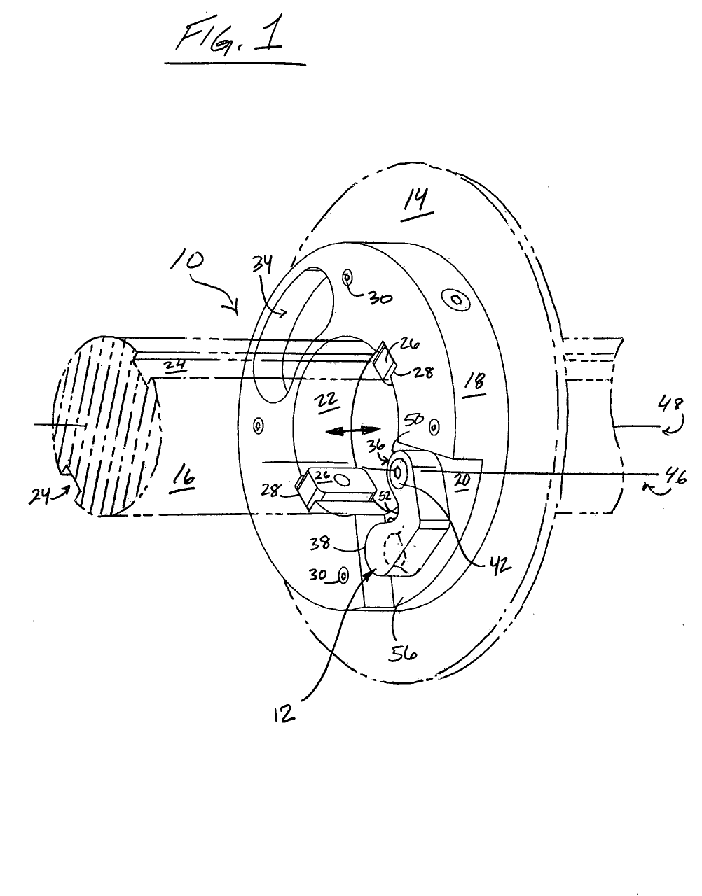

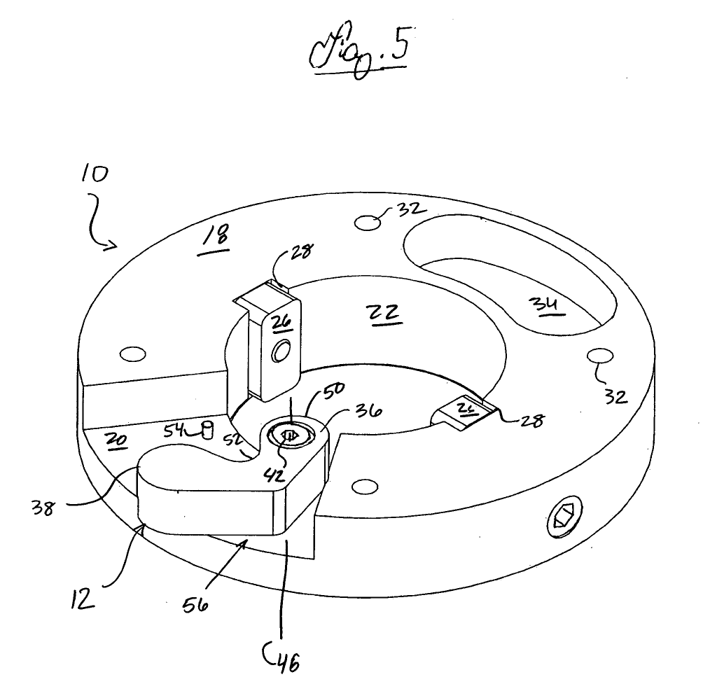

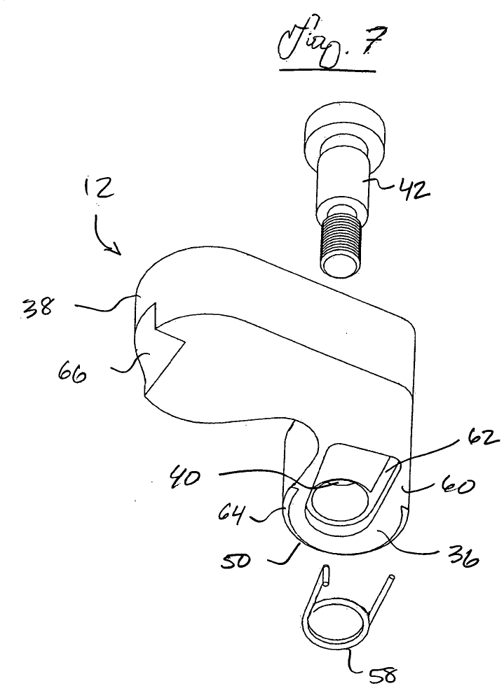

The self-locking collar assembly 10 of the subject invention is generally depicted in FIGS. 1-6, and otherwise hidden features of a self-locking link 12 thereof depicted in FIG. 7. General functionality of the device 10 is readily appreciated with reference to FIGS. 1-4, while the elements or structures thereof are the focus of FIGS. 5-7.

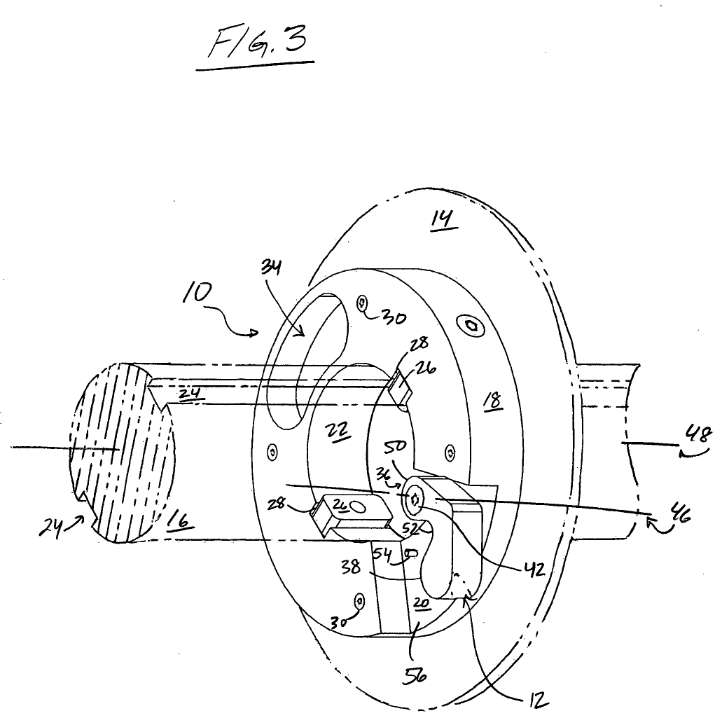

With general reference to FIGS. 1-4, the self-locking collar assembly 10 of the subject invention is illustrated in combination with a saw blade 14, the combination shown received upon a spindle or arbor, more particularly, an arbor 16. The arrangements or configurations of FIGS. 1 & 2, as will later be discussed, generally permit axial translation of the assembly 10 along the spline 16, whereas, the arrangements or configurations of FIGS. 3 & 4, as will also later be discussed, generally prohibit unintended axial translation of the assembly 10 along the spline.

As a preliminary matter, it is to be noted and readily appreciated that the following description of the subject assembly, particularly the functionality thereof, is illustrative, and is in no way intended to be limiting. For example, in lieu of a “collar” or the like, a saw blade hub or boss may be suitable adapted so as to perform the critical functionality of the assembly to be described.

Referring again generally to FIGS. 1-4, the self-locking collar assembly 10 generally includes a collar 18, and a self-locking link 12 pivotally mounted at an end thereof to a portion of a surface 20 of the collar 18. As will be later discussed in relation to FIGS. 5-7, the self-locking link 12 is advantageously mounted with respect to the collar 18 so as to be under tension.

The collar 18, generally adapted to be affixed to a saw blade 14, or alternately equivalently provided so as to be integral thereto as by a hub, boss, etc., includes an inner periphery 22 adapted for receipt upon an arbor, more particularly and advantageously, spline 16 as shown. As illustrated, the spline 16 preferably, but not necessarily includes opposingly paired keyways 24 (FIGS. 1 & 3), the collar assembly 10 correspondingly including opposingly paired keys 26 inwardly extending from opposingly paired keyways 28 which traverse a face, i.e., the thickness, of the inner periphery 22 of the collar 18 (FIGS. 1 & 3). The illustrated details of this arrangement are intended as environmental background or context for the subject invention, it being understood that the subject arrangement, including but not limited to alternate, and/or equivalent splined interfaces, is not intended to be limiting.

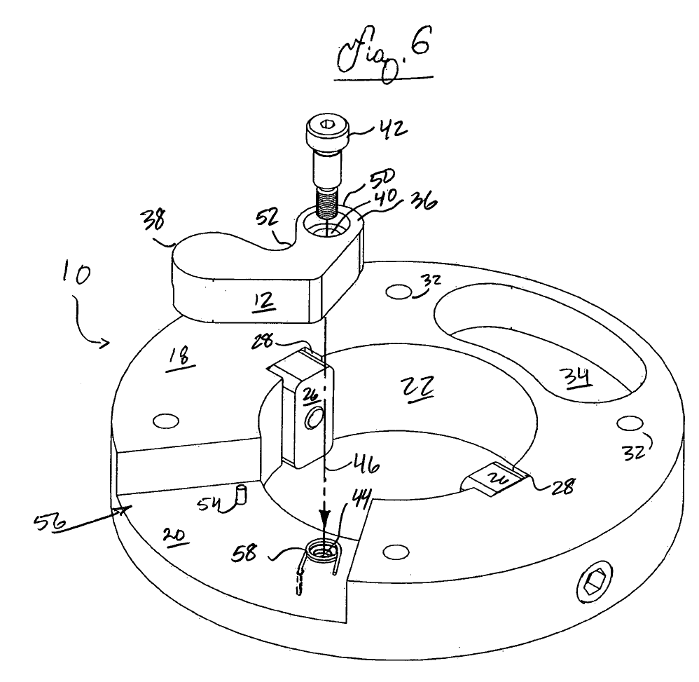

As shown, saw integrating fasteners 30 are received through spaced apart through-holes 32, FIG. 5, in the collar 18 which traverse a thickness thereof. Furthermore, a large relief area or volume 34 is provided in the collar 18, as by milling, opposite the self-locking link 12, so as to provide balance, i.e., mechanical stability, at the typical 3,600 rpm maximum operating speed of the spline/saw. The self-locking link 12 is generally configured so as to be responsive to centrifugal force imparted from the rotating spline to and through the collar, a force which readily overcomes the tensioned interface of the link 12 relative to the collar 18. The link 12 generally includes opposing ends, namely, a spline engaging lobe 36 opposite a free end 38 thereof. As illustrated, the link 12, more particularly, the spline engaging end 36, is mechanically united to the collar 18 for pivot motion, i.e., rotation, with respect thereto. More particularly, the spline engaging lobe 36 includes a through-hole 40 for receipt of a fastener 42 which is receivable in an bore 44 of a surface of the collar 18 (FIG. 6), thus defining a pivot axis 46 for the link, an axis substantially parallel to an axis of rotation 48 for the spline 16.

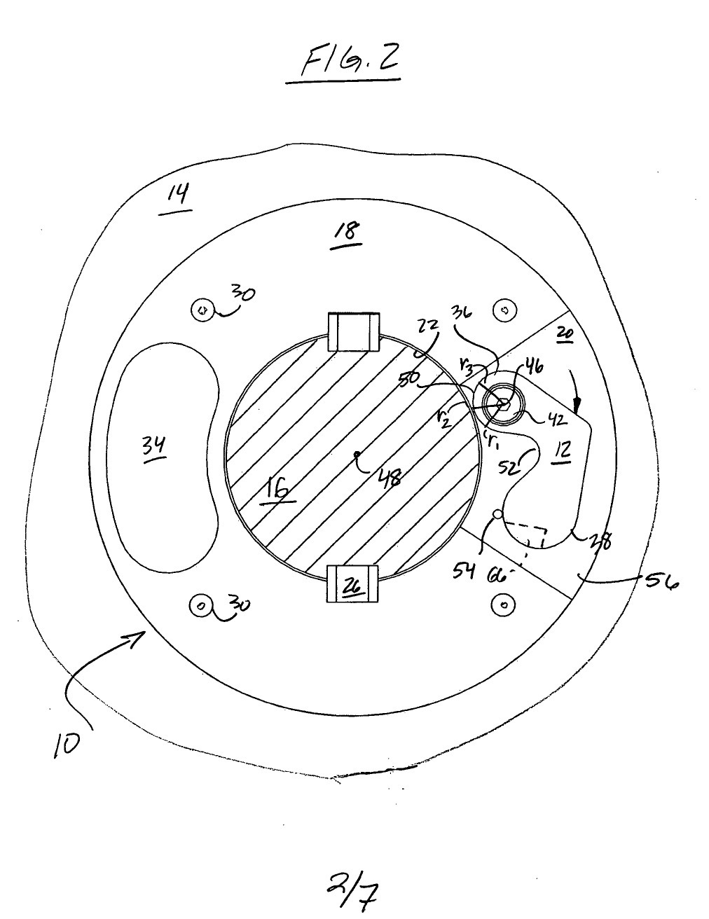

The spline engaging lobe 36 advantageously includes an eccentrically configured sidewall or camming surface 50(FIGS. 2 & 4). As indicated with respect to FIG. 2, there is a non-constant or variable radial distance between the pivot axis 46 and the sidewall 50 of the spline engaging lobe 36, i.e., r₃>r₂>r₁. With such a sidewall configuration, there results a camming interface between the self-locking link 12 vis-a-vis the spline engaging lobe 36, more particularly, a wedging or progressive locking effect for the spline engaging lobe 36 relative to the spline 16. Further features of the spline engaging lobe 36 shall be later presented and discussed in relation to FIGS. 5-7.

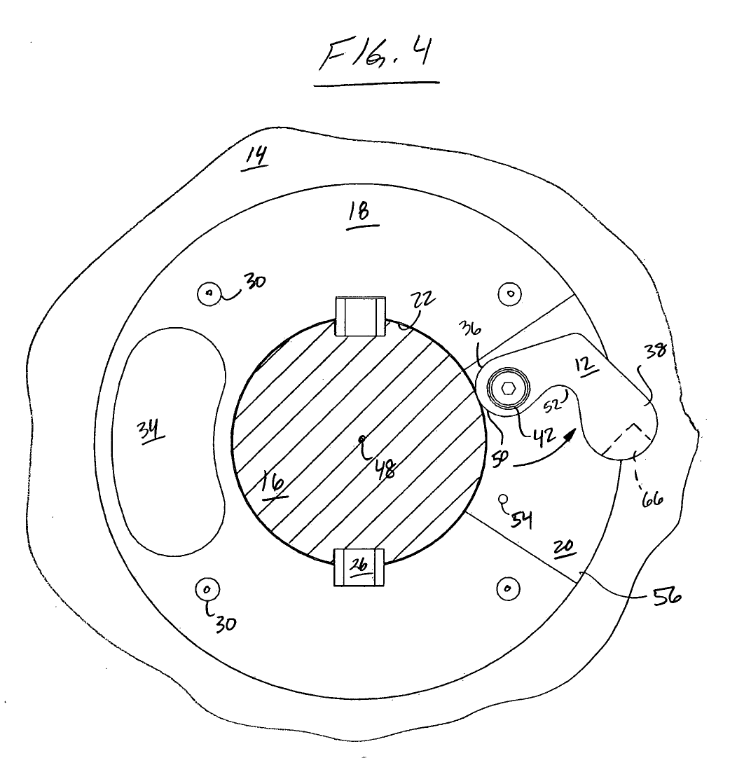

With regard to the free end 38 of the self-locking link 12, it is advantageously, but not necessarily, configured so as to be lobe-like. Furthermore, the free end 38 of the link 12 is to have a sufficient area, i.e., mass, so as to outwardly swing with rotation of the spline 16 (FIG. 4). As shown, a crotch 52 delimits the more massive free end lobe 38 from the spline engaging lobe 36. With higher rpms, the free end 38 of the link 12 progressively travels through an arcuate path, the travel thereof terminating upon a supremely tight interference fit between the spline 16 and the spline engaging lobe 36, more particularly, the eccentric sidewall 50 thereof.

Functionally, the self-locking link 12 is pre-tensioned, as will later be described, such that a portion of the spline engaging lobe 36 inwardly extends beyond the inner periphery 22 of the collar 18, i.e., the perimeter of the inner periphery 22 of the collar 18, that is to say, the spline conforming periphery 22 of the collar 18 is “interrupted” by a portion of the spline engaging lobe 36, e.g., the region associated with the r₂₋r₃ segment of the eccentric sidewall 50. This condition or state for the assembly is associated with an assembly 10 “out-of-the-box,” e.g., see the arrangement of FIG. 5. As will be later discussed, the link is readily manipulated for increased pre-tensioned axial positioning of a saw blade upon the arbor, or for overcoming a tensioned interface of the saw blade upon the arbor.

To achieve the “fit” or arrangement of FIGS. 1 & 2, the free end 38 of the link 12, i.e., the major lobe, is radially directed inward by an operator, thereby overcoming the tension associated with the link 12, so as to clear the spline engaging lobe 36, i.e., the portion thereof previously described, from the inner periphery 22 of the collar 18. A stop 54 extends from the surface 20 of the collar 18 (see e.g., FIGS. 2 & 3) to limit pivoting, i.e., inward travel of the free end 38 of the link 12, and thus preserve the pre-tensioned condition therefor. With the collar 18 slidingly received upon the spline 16, FIGS. 1 & 2, release of the free end 38 of the link 12 results in an affixation of the assembly 10 upon the spline 16, FIGS. 3 & 4, via an initial frictional engagement of the spline engaging lobe 36 of the link 12 with the spline 16. With such arrangement of elements and associated functionality, preselected, targeted spaced apart saw blade relationships are maintained throughout the blade arrangement process, and initial saw start up, i.e., spline rotation. Proceeding from initial saw start up to full operation, the self-locking link 12 pivots about the pivot axis 46, more particularly, the free end 38 thereof, under centrifugal force, is outwardly thrust (FIG. 4) with the eccentric sidewall 50 progressively wedging against the rotating spline so as to define an interference fit for the saw relative thereto.

Referring now generally to FIGS. 5-7, the collar 18 preferably, but not necessarily, includes a surface having a cut-out segment 56 for receipt of the self-locking link 12. Advantageously, such discontinuous surface, opposite the saw blade surface, facilitates close tolerance blade spacing upon the spline, i.e., the thickness of only the collar need be accounted for in the spacing as opposed to the combined thickness of the collar and link. As previously noted, a relief 34 is provided in the collar 18 opposite the link 12, more particularly, opposite the cut-out segment 56.

Referring now particularly to FIGS. 6 & 7, the pre-tensioned condition for the link 12 is advantageously, but not necessarily, enabled, as shown, by a hairpin spring 58 disposed between the link 12 and the collar 18. It is to be understood that other tensioning mechanisms, and accompanying component arrangements, are contemplated.

As evidenced by FIGS. 6 & 7, the tensioning element 58 operatively unites the collar 18 and the link 12. The tensioning element 58 is secured at one end to the collar 18, with the remainder thereof essentially housed within a recessed surface 60 of the link. As shown, the recess 62, which is generally configured to receive a portion of the tensioning element 58, is adjacent or proximal the through hole 40 of the link 12, more particularly, the spline engaging lobe 36 thereof. The link fastener 42 further integrates the collar 18, tensioning element 58, and link 12 as shown (FIG. 6).

For installation of the assembly 10, as previously and briefly discussed in relation to FIGS. 1-4, an operator would push down slightly on the camming link 12, more particularly, the free end thereof 38, to overcome the slight pressure of the hairpin spring 58, and slide the saw/collar onto the spline 16, and thereafter translate same for select positioning thereon. The hairpin spring provides initial tension for presetting the position of the collar. While, for example, holding a pre-cut piece of hardwood against the side of one or two of the saw blade teeth, the operator would slide the next saw collar assembly to the wood, and use the wood as a gauge. As is readily appreciated, it is contemplated and advantageous to utilize a digital setting device so as to provide an exact position, within a few thousandths of an inch. Upon release of the camming link 12, the hairpin spring 58 pre-tensions the collar 18 for ease of setting, and also prevents drifting when the arbor is started. The operator would continue to set the next or subsequent collars using corresponding blocks of wood until all of the collars are set so as to produce the desired net rips. When the saw is started, centrifugal force causes the camming link to rotate radially, and thereby provide or impart a locking force on the arbor due to the camming surface of the link in engagement therewith. This force will be consistently and simultaneously be placed on all collars because all the cams have substantially the same mass.

Further advantageous, non-limiting features of the self-locking link 12 include a relieved edge 64 for the eccentric sidewall 50 of the spline engaging lobe 36, and a cut-out 66 in a portion of the free end 38 of the link 12(FIG. 7). Inclusion of the relieved edge 64 for the eccentric sidewall 50 prevents burr formation between the adjacent contacting surfaces of the collar 18 and the link 12, and thus maintains an unencumbered pivot path for the link. Wear issues are further advantageously minimized, as for example via hardening of the link with a melonite®, or equivalent process, which likewise improves the lubricity of the link, and thereby minimizes fretting corrosion.

As to the cut-out 66 of the free end 38 of the link 12, it is provided as a “catch” for a work piece, i.e., a link manipulating tool, more particularly, the spline engaging lobe 36 thereof. The release tool, in combination with the cut-out 66 of the free end 38 of the link 12, is advantageously used to reach between two closely-positioned collars to more firmly pre-lock a saw blade axially upon the arbor, i.e., displace free end of lobe 38 from stop 54, effectively, resulting in a departure from the arrangement of FIG. 2.

As should be further appreciated, rearranging of saws on the spline requires disabling of the wedged interface of the eccentric sidewall 50 of the spline or arbor engaging lobe 36 from the spline or arbor 16 (FIG. 4). In-as-much as the frictional engagement may be overcome by supplying a force to that portion of the free end 38 of the link 12 extending beyond the periphery of the outer edge of the collar 18, typical spatial arrangements between saw blades upon the arbor, as previously noted, are not necessarily conducive for delivering a loosening blow. Beyond the contemplated use of a tool to tap upon the free end 38 of the link 12 in furtherance of rotating the link towards the arbor (i.e., more particularly, stop 54) and thereby releasing the saw blade from the arbor, the cut-out may further be configured to receive an operative end of a tool for such purpose, i.e., return the link to the arrangement of FIG. 2 from the arrangement of FIG. 4.

Finally, there are other variations of the subject invention, some of which will become obvious to those skilled in the art. It will be understood that this disclosure, in many respects, is only illustrative. Changes may be made in details, particularly in matters of shape, size, material, and arrangement of parts, as the case may be, without exceeding the scope of the invention.

1. A self-locking collar assembly for a saw blade comprising:
a. a collar having an inner periphery adapted for receipt upon a spline, said collar adapted for affixation to a saw blade;
b. a self-locking link pivotally mounted at an end thereof to a portion of a surface of said collar, said self-locking link comprising a spline engaging lobe for axially affixing the saw blade to the spline in furtherance of producing a pre-select dimensional rip of a work piece.

2. The self-locking collar assembly of claim 1 wherein said self-locking link is pivotally mounted to said portion of said surface of said collar at said spline engaging lobe.

3. The self-locking collar assembly of claim 1 wherein said self-locking link is pivotally mounted to said portion of said surface of said collar so as to be under tension.

4. The self-locking collar assembly of claim 1 wherein said spline engaging lobe includes an eccentrically configured sidewall.

5. The self-locking collar assembly of claim 4 wherein said spline engaging lobe includes a through hole defining a pivot axis for said self-locking link.

6. The self-locking collar assembly of claim 5 wherein said self-locking link is tensioningly supported by said collar.

7. The self-locking collar assembly of claim 6 wherein a portion of said spline engaging lobe extends beyond said inner periphery of said collar.

8. The self-locking collar assembly of claim 6 wherein said spline engaging lobe is in frictional engagement with the spline subsequent to select axial positioning of the saw blade upon the spline so as to maintain a select axial position for the saw blade upon the spline.

9. The self-locking collar assembly of claim 8 wherein said frictional engagement of said spline engaging lobe with the spline increases upon rotation of the spline.

10. The self-locking collar assembly of claim 8 wherein said frictional engagement of said spline engaging lobe with the spline progressively increases upon rotation of the spline.

11. The self-locking collar assembly of claim 8 wherein said eccentrically configured sidewall wedgingly engages the spline during rotation thereof.

12. The self-locking collar assembly of claim 4 wherein said self-locking link includes a free end opposite said spline engaging lobe.

13. The self-locking collar assembly of claim 12 wherein said free end travels an arcuate path from a static position with rotation of the spline.

14. The self-locking collar assembly of claim 13 wherein said free end comprises a lobe.

15. The self-locking collar assembly of claim 13 wherein said free end is adapted to receive a work piece in furtherance of disengaging said spline engaging lobe from the spline.

16. The self-locking collar assembly of claim 13 wherein said free end of said self-locking link includes a surface adjacent a surface of said collar.

17. The self-locking collar assembly of claim 16 wherein said surface adjacent said surface of said collar includes a recessed portion.

18. The self-locking collar assembly of claim 17 wherein said recessed portion extends through a portion of a sidewall of said free end of said self-locking link.

19. The self-locking collar assembly of claim 5 further comprising tensioning means interposed between said self-locking link and said collar.

20. The self-locking collar assembly of claim 19 wherein a surface of said spline engaging lobe proximal to said through hole includes a recess for retention of at least a portion of said tensioning means.

21. A saw blade for selective axial positioning upon an arbor of a sawing machine, said saw blade including a hub adapted to pivotingly receive a pre-tensioned locking link, said locking link including a camming surface adjacent a pivot axis of said locking link for cooperative engagement with the arbor in furtherance of developing a progressive interference fit therebetween upon rotation of the arbor.

22. A sawing machine comprising an arbor and a plurality of sawing blades selectively positionable so as to be axially spaced apart thereon, each of said sawing blades comprising a pre-tensioned locking element for secured positioning of said each of said sawing blades upon said arbor, said pre-tensioned locking element comprising a lobed end for wedged engagement with said arbor upon rotation of same, said pre-tensioned locking element united to each of said saw blades at said lobed end.
